(19) United States
(12) Patent Application Publication
(10) Pub. No.: US 2015/0252608 A1
(43) Pub. Date: Sep. 10, 2015

(54) SUBTERRANEAN HYDRAULIC SECURITY SYSTEM AND METHOD OF USE

(71) Applicants: Michael Shawn Hall, Hurricane, UT (US); Jason Neil Hall, Hurricane, UT (US)

(72) Inventors: Michael Shawn Hall, Hurricane, UT (US); Jason Neil Hall, Hurricane, UT (US)

(21) Appl. No.: 14/639,110

(22) Filed: Mar. 4, 2015

Related U.S. Application Data
(60) Provisional application No. 61/947,835, filed on Mar. 4, 2014.

(51) Int. Cl. E05G 1/10; E05G 1/026

(52) U.S. Cl. CPC E05G 1/10; E05G 1/026; E05G 2700/02

(57) ABSTRACT

In one embodiment, a subterranean hydraulic security system comprises a safe, support legs, and a lifting means, such as a hydraulic scissor lift and a pump, a screw jack, or other equivalent means. The underground safe system may also comprise an oversized upper portion formed from concrete, wood, or other rigid material.

In another embodiment, a subterranean hydraulic security system comprises a gate, securing posts, and a lifting means.

### CROSS-REFERENCE TO RELATED APPLICATIONS

This application claims the benefit of U.S. Provisional Application Ser. No. 61/947,835, filed on Mar. 4, 2014, and is incorporated herein by reference.

### TECHNICAL FIELD

The present invention relates to hydraulic lifts. More particularly, the present invention relates to a subterranean hydraulic system for raising and lowering safes, gates, and other structures.

### BACKGROUND

Security over one's property, whether personal or real, has always been a high priority. As such, individuals have secured their property in several ways, including fencing off their real property and securing their personal property inside a locked safe. However, these security measures not only remain vulnerable, but they often take a sizeable amount of floor space (in the case of a safe), or open space (in the case of a gate). There remains a need to overcome these issues.

Several problems exist when securing valuables, firearms, or other items, in a standard safe. First, an intruder knows immediately where the valuable items are kept. Aside from being exposed to intruders, safes are also exposed to disasters such as fires or hurricanes and tornadoes. Many safes attempt to overcome these limitations by adding fireproof materials and/or bolts to secure it to a wall or floor. However, in many instances, these safes remain be vulnerable. Large safes can take up a significant amount of floor space, which may also be undesired. Therefore, there remains a need for a safe that is hidden from sight, secure, and protected from disasters.

With the gate, it often slides to the side to allow entry/exit, or will part in the center to swing open on hinges. Both of these methods require a large amount of open space, which many properties do not have. Further, any hinged gate poses a vulnerability, as an intruder may simply exert pressure on the closure and either comprise the closure or the arm (i.e., if the gate is mechanical or electrical). Therefore, there remains a need for a gate that does not require additional open space to open and that does not have pressure vulnerabilities.

The present invention seeks to solve these and other problems.

### SUMMARY OF EXAMPLE EMBODIMENTS

In one embodiment, a subterranean hydraulic security system comprises a safe, support legs, and a lifting means, such as a hydraulic scissor lift and a pump, a screw jack, or other equivalent means. The underground safe system may also comprise an oversized upper portion formed from concrete, wood, or other rigid material.

In one embodiment, the safe comprises a locking system, such as a key lock, combination, biometric, or equivalent. In another embodiment, the lifting mechanism comprises the locking system.

In another embodiment, a subterranean hydraulic security system comprises a gate, securing posts, and a lifting means.

### BRIEF DESCRIPTION OF THE DRAWINGS

FIG. 1 is a sectional view of an underground safe in a raised position

FIG. 2 is a sectional view of an underground safe in the concealed position

FIG. 3 is a sectional view of a gate in a raised position

FIG. 4 is a sectional view of a gate in a lowered position

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of any and all equivalents thereof. Moreover, many embodiments, such as adaptations, variations, modifications, and equivalent arrangements, will be implicitly disclosed by the embodiments described herein and fall within the scope of the present invention. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

Further, although the term “safe” is used throughout this disclosure, it refers to any type of container capable of storage, whether locked or unlocked.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

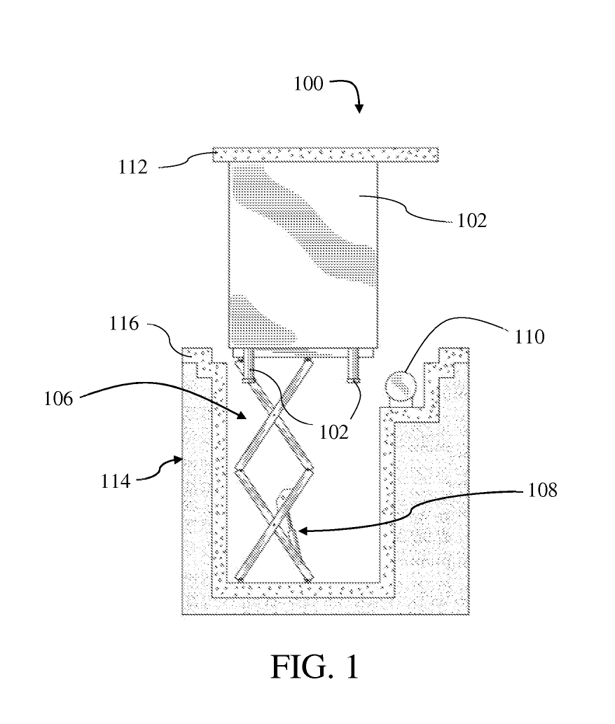

In one embodiment, as illustrated in FIG. 1, a subterranean hydraulic security system 100 comprises a safe 102, support legs 104, and a lifting means. As shown in FIG. 1, the lifting means may be a hydraulic scissor lift 106, coupled to a piston and cylinder 108 and a pump 110. It will be appreciated by those with skill in the art that while the example of a hydraulic scissor lift 106 is used, a screw jack, one or more hydraulic cylinder jacks (i.e., without scissors), a pneumatic piston, or any other equivalent means may likewise be used. The pump 110 is preferably a small standard electrical hydraulic pump that is capable of actuating the scissor lift 106.

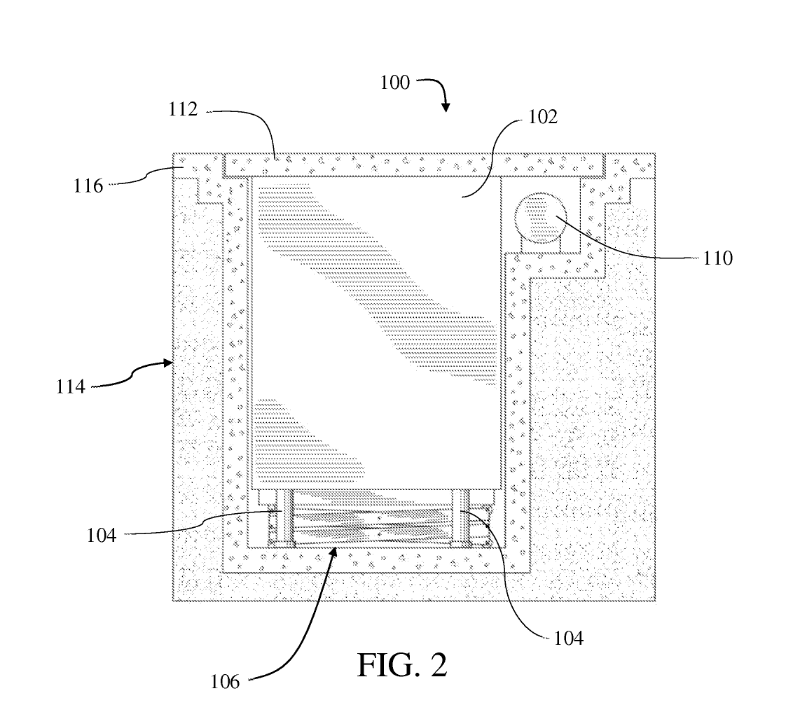

The subterranean hydraulic security system 100 may also comprise an oversized upper portion 112 formed from concrete, wood, or other rigid material for concealing and/or protecting the safe 102 and may be of the same material as housing 116. The subterranean hydraulic security system 100 is sufficiently deep in the ground 114 such that the oversized upper portion 112 remains flush with the ground and/or housing 116 when lowered, as shown in FIG. 2.

In one embodiment, the safe 102 comprises a typical locking system (not shown), such as a key lock, combination, biometric, or equivalent. For example, a user desiring to access the safe 102 would use the pump 110 to actuate the hydraulic scissor lift 106, raising the safe 102 from below the ground 114. A user would then unlock the safe 102 to access its contents.

In another embodiment, a lifting means (e.g., scissor lift and pump) may comprise a locking system. For example, the pump 110 may be located behind an access panel, which may be locked, such as with a key or combination. In another example, using remote electronic access, a digital password or personal identification number may be required before a circuit is closed which actuates the pump 110. In yet another example, a lock box may enclose a button or switch that actuates the pump 110. This allows the safe 102 to remain concealed until an authorized user, using one of the methods outlined above (e.g., key, combination, digital access, etc.), actuates the pump 110 and raises the safe 102. As an additional layer of protection, the safe 102 may also still contain a locking system, although not required.

If using a locking system external to the safe 102, such as on the access panel to the pump 110, the safe 102 may be made from various materials, should a user desire. For example, hard metals may be used, but a user may also desire to use plastics, carbon fibers, fiberglass, or other lightweight yet rigid materials. Having a lighter safe 102 allows a user to store more without necessitating an overly large lifting means, such as a larger pump 110 and scissor lift 106.

A method of securing items underground comprises digging a hole in the ground of sufficient size to conceal a safe and a lifting means, wherein the safe comprises an oversized upper-portion to conceal it (e.g., wood or concrete), and raising and lowering the safe using a lifting means, such as a hydraulic scissor lift. The oversized upper-portion may be separately attached to the safe or it may be manufactured as one whole.

In yet another embodiment, a subterranean hydraulic security system 200 comprises a gate 202, securing posts 204A, 204B, and a lifting means 206. The securing posts 204A, 204B are preferably of single manufacture and extend from below the ground 208 to at least the same height as the gate 202. In one embodiment, the securing posts 204A, 204B have grooves on the side proximal to the gate for receiving a tongue portion of the gate 202. The grooves allow not only for guidance of the gate 202 as it raises and lowers, but also adds additional protection when the gate 202 is in the raised position by anchoring the gate 202 to the securing posts 204A, 204B, which are embedded below the outer surface 209 (which may or may not be level with the ground 208). The same effect may be accomplished using flanges on the gate 202 instead. In other words, the gate 202 may have one or more flanges that extend around the securing posts 204A, 204B. Further, the lifting means 206 may comprise scissor lifts as illustrated in the figures (which are actuated by a pump and piston and cylinder mechanism 207), but may also be a linear actuator as well, such as a hydraulic or pneumatic piston, a screw jack, or other equivalent means.

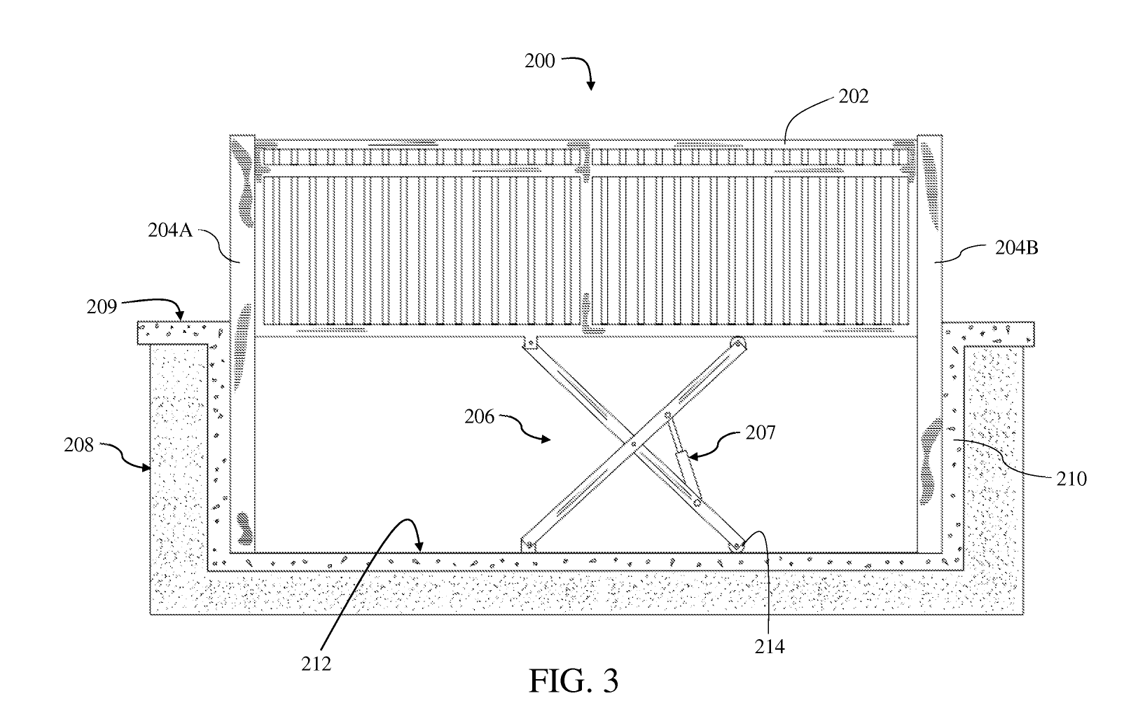

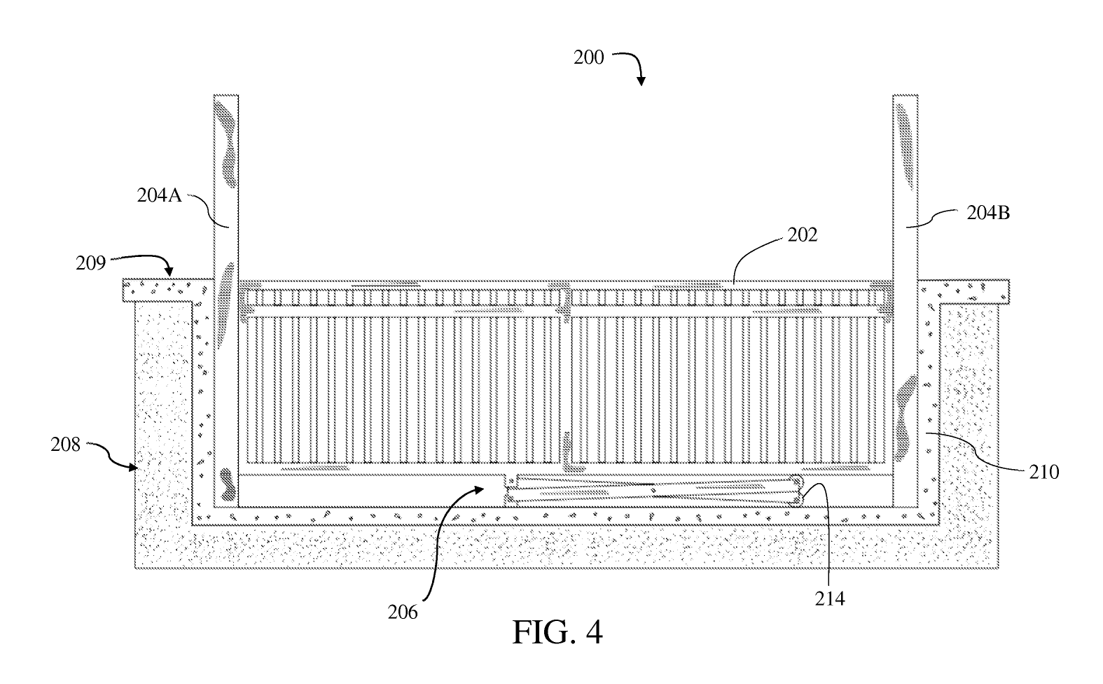

In a preferred embodiment, the gate 202 lowers into a housing 210 that protects the gate from rocks, dirt, or other debris. The housing 210 may be made from cement, metals, or other rigid materials that are resistant to the effects of corrosion. The housing 210 ideally comprises a floor 212 that allows a stable setting for the lifting means 206 as well, and as FIGS. 3 and 4 illustrate, allow the wheel 214 on the lower scissor member to roll freely. For example, in one embodiment, the lifting means 206 comprises a piston and cylinder operably coupled or otherwise connected to an electrical pump. When the pump is started by a user, the piston extends, which actuates the scissors, wherein the wheel 214 rolls along the floor 212. In one embodiment, one or more support legs (not shown) may be included, which removes the pressure from the scissor lift—or other lifting means. When the gate is in a raised position, as illustrated in FIG. 3, the gate 202 prevents entry or exit and is more effective against ramming efforts from an intruder, due to the solid construction and connection to the securing posts. When a user desires to open the gate 202, the user actuates the pump, which allows the scissor lift to collapse and gate 202 to lower into the ground to a subterranean state as shown in FIG. 4. This has several benefits, including the ability to have a large gate without requiring an equally large area adjacent to the gate to fully open it. It also removes the weakness of hinges and clasps or other closures that are susceptible under pressure. This creates an additional level of security by preventing intruders from forcing or ramming the gate open, which prohibits them from accessing the real property. It will be appreciated that access to the hydraulic pump may be restricted by using a locking system. For example, in order to lower the gate 202, a user must first access and actuate the hydraulic pump, which may be as simple as closing an electrical circuit such as by flipping a switch. To prevent unauthorized access, access to the pump may be restricted by a number of locking systems, as discussed in previous embodiments, such as a key, combination, digital code, etc. Further, the use of wireless remote systems for actuating the pump are also contemplated herein. For example, a user may have a signal transmitting device, which transmits a unique signal to a signal receiving device that is electrically coupled to the electric hydraulic pump, which thereby actuates the pump. These systems are well-known in the art, being used in standard garage door openers for many years. These and equivalent methods are specifically contemplated and incorporated herein.

Further, the pump may be external or internal to the system. In either embodiment, the user may control the pump using a lever, an electric switch, or similar means.

In another embodiment, the lifting means may be comprised of one or more stationary hydraulic cylinder jacks. For example, instead of the scissor lifts, one or more cylinder jacks are connected to the floor 212 and to the gate 202, such as by bolting them. A user would then actuate a pump, which would raise the piston cylinder, which in turn raises the gate 202.

The gate 202 is ideally made from metal, steel, or other suitably rigid materials that are capable of creating a barrier to entry. The gate may be further coated in materials known to those in the art to prevent corrosion.

It will further be appreciated that while pump hoses and electrical connections are not explicitly shown in the drawings, those in the art know and understand how to connect or otherwise couple the pump to the hydraulic piston and cylinder. Also, it will be further appreciated that the piston and cylinder may be connected to the scissor lifts in a variety of places. For example, the drawings generally illustrate the piston and cylinder as being directly connected to both the upper and lower scissor arms. However, in another embodiment, the cylinder may be mounted to the floor of the housing while the piston is attached to one of the scissor arms directly or to a crossbar between multiple scissor arms, as is common and well known in the art.

What is claimed is:

1. A subterranean hydraulic security system, comprising:
a container for holding one or more items of personal property;
a subterranean housing for receiving the container, wherein the top of the housing is formed from an upper portion connected to the container; and
a lifting means for raising and lowering the container from within the housing.

2. The subterranean hydraulic security system of claim 1 further comprising at least one support leg for the container.

3. The subterranean hydraulic security system of claim 1, wherein the lifting means comprises a hydraulic pump operably connected to at least one cylinder and piston.

4. The subterranean hydraulic security system of claim 3 further comprising a scissor lift.

5. The subterranean hydraulic security system of claim 1 further comprising one or more locking systems.

6. The subterranean hydraulic security system of claim 5, wherein the locking system is on the container.

7. The subterranean hydraulic security system of claim 5, wherein the locking system is an keyed access panel to the lifting means.

8. A subterranean hydraulic security system, comprising:
a gate;
a subterranean housing for receiving the gate;
a first securing post and a second securing post; and
a lifting means for raising and lowering the gate from within the housing.

9. The subterranean hydraulic security system of claim 8, wherein the gate comprises a tongue on a first side and a tongue on a second side and wherein the first securing post and the second securing post comprise grooves for receiving the tongues of the gate.

10. The subterranean hydraulic security system of claim 8, wherein the gate has one more flanges for coupling with the first securing post and the second securing post.

11. The subterranean hydraulic security system of claim 8, wherein the lifting means comprises a hydraulic pump operably connected to at least one cylinder and piston.

12. The subterranean hydraulic security system of claim 11 further comprising a scissor lift.

13. The subterranean hydraulic security system of claim 8 further comprising one or more locking systems.

14. The subterranean hydraulic security system of claim 13, wherein the locking system is a keyed access panel.

15. The subterranean hydraulic security system of claim 8, further comprising a wireless transmitting device for transmitting a signal to a signal receiving device, wherein the signal receiving device is electrically coupled to and thereby actuates the lifting means.

16. The subterranean hydraulic security system of claim 8, further comprising one or more support legs.

17. A method of preventing unauthorized access to real property using a subterranean hydraulic security system, comprising:
installing a gate at the access point to real property, wherein there is a subterranean housing for receiving the gate; and wherein a user may selectively raise or lower the gate to prevent unauthorized access to the property.
